(19) United States
(12) Patent Application Publication
(10) Pub. No.: US 2006/0196823 A1
(43) Pub. Date: Sep. 7, 2006

(54) Filter media-to-plastic adhesion method and apparatus

(75) Inventors: Christopher P. Desmarais, Garner, NC (US); Richard Hedgepeth, Fayetteville, NC (US); Randy C. Frye, Coats, NC (US)

Correspondence Address: CARLSON, GASKEY & OLDS, P.C., 400 WEST MAPLE ROAD, SUITE 350, BIRMINGHAM, MI, 48009, US

(73) Assignee: Arvin Technologies, Inc.

(21) Appl. No.: 11/071,337

(22) Filed: Mar. 3, 2005

(51) Int. Cl. B01D 27/00

(52) U.S. Cl. 210/437; 210/440; 210/456

(57) ABSTRACT

A filter assembly and method of manufacturing the same is provided that uses an inductive heating system to secure a heat sensitive filter media to a plastic base. A metal disc is arranged between the plastic base and filter media with adhesive material arranged between the filter media and metal disc. The metal disc is excited using an inductive heating system to heat and care the adhesive material without damaging the filter media.

### BACKGROUND OF THE INVENTION

This invention relates to a method and apparatus for adhering a filter media to a plastic member such as a fuel filter diverter.

Filter assemblies include a filter media to filter debris from a fluid. Filter medias are often bonded to a structural component by using a heat curable adhesive material such as plastisol. In some filter applications, such as automotive fuel filters, a heat sensitive filter media is used. One typical heat sensitive filter media is constructed from polyester, which tends to degrade in structural integrity and performance when it has been subjected to heat of 325° F. or more. Plastisol is typically cured by heating the plastisol along with the fuel filter diverter and filter media in a relatively long oven, which exposes the heat sensitive filter media to higher than desired temperatures.

Hot melt glues and epoxies can be used to secure the heat sensitive filter media to the fuel filter diverter to obviate the need for an oven. It is desirable to utilize a plastic fuel filter diverter for various reasons. However, current hot melt glues and epoxies that are compatible with suitable plastics for fuel filter diverters are not able to withstand the chemicals that are typically present in fuel filter applications.

Therefore, what is needed is an apparatus and method of securing a heat sensitive filter media to a plastic structure, such as a fuel filter diverter, without damaging the heat sensitive media.

### SUMMARY OF THE INVENTION

The present invention provides a filter assembly including a plastic base and a metal member secured to the plastic base. In the example of a fuel filter assembly, the plastic base may be provided by a fuel filter diverter, which may also include an integrated center tube. A filter media is secured to the metal member with a heat-curable adhesive material, such as plastisol. The metal member acts as an end disc for the filter media.

The plastic base may be over-molded around the metal member, or the metal member may be secured to the plastic base subsequent to its forming.

The heat-curable adhesive material is dispensed in a desired manner. For example, the heat-curable adhesive material may be dispensed directly onto the metal member. The filter media is arranged on the metal member with the heat-curable adhesive material arranged between the filter media and metal member.

Induction heating is used to generate localized heat in the metal member to heat and cure the heat-curable adhesive material. In this manner, the filter media, which may include a heat sensitive polyester, is not subjected to damaging levels of heat.

Accordingly, the present invention provides a method and apparatus that secures a heat sensitive filter media to a plastic structure without damaging the filter media.

These and other features of the present invention can be best understood from the following specification and drawings, the following of which is a brief description.

### BRIEF DESCRIPTION OF THE DRAWINGS

FIG. 1 is a cross-sectional view of a fuel filter assembly with the metal member of FIG. 2.

FIG. 2 is a top elevational perspective view of one example metal member.

FIG. 3A is a top elevational perspective view of another example metal member.

FIG. 3B is a cross-sectional view of a fuel filter diverter with the metal member of FIG. 3A.

FIG. 4 is a flow chart depicting the inventive method of securing the filter media.

FIG. 5 is a perspective view of an inductive heating system used to cure a heat-curable adhesive material.

### DETAILED DESCRIPTION OF THE PREFERRED EMBODIMENT

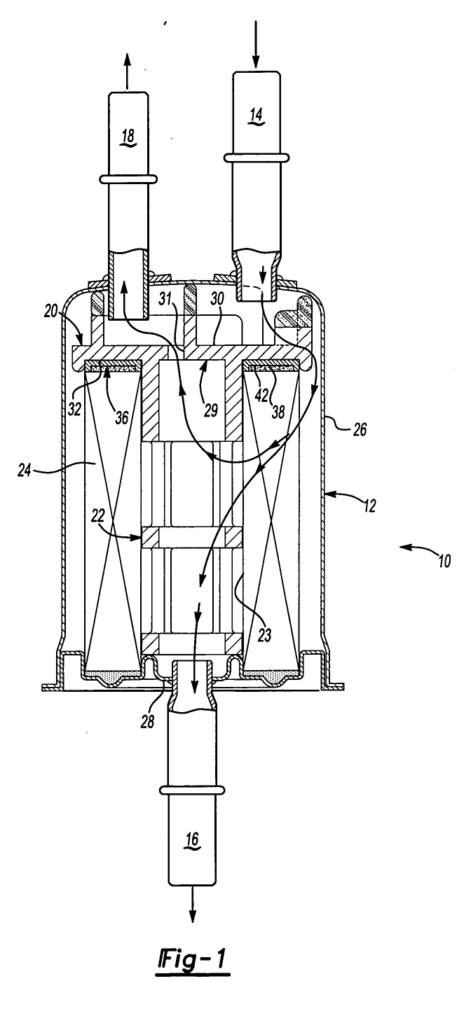

A filter assembly 10, and more specifically a fuel filter assembly, is shown in FIG. 1. The filter assembly 10 includes a housing 12 having inlet, outlet and return tubes 14, 16 and 18. A diverter 20 is arranged within the housing 12 to provide separate flow paths within the filter assembly 10.

In the example shown, the diverter 20 is constructed from a plastic material. A center tube 22 extends from the diverter 20 toward the outlet tube 16. The center tube 22 is integrally formed with a base 29 of the diverter 20. A filter media 24 having a central opening 23 is supported by the diverter 20 with the center tube 22 arranged within the central opening 23.

The housing 12 includes a case 26 and a cover 28 that is secured to the case 26 in a known manner. A first side 30 on the base 29 of the diverter 20 is sealed against a bottom of the case 26 to fluidly separate flow through the inlet and return tubes 14 and 18. The diverter 20 is typically sealed against the case 26 with a load exerted on the diverter 20 by the cover 28. An opening 31 in the diverter 20 allows flow of fluid to the return tube 18.

The filter media 24 is sealed between a second side 32 on the base 29 and the cover 28 using an adhesive material 38, typically plastisol. In this manner, fluid is prevented from circumventing the filter media 24. In fuel filter applications, the filter media 24 is typically constructed from a material that includes polyester, which is heat sensitive. The filter media 24 may be constructed from primarily polyester, or the filter media 24 may be constructed from a cellulose substrate having a polyester layer. The integrity and performance of polyester typically degrades when exposed to temperatures of approximately 325° F. or greater.

Adhesive material such as plastisol cannot be cured using conventional ovens when used in conjunction with polyester-containing filter media since the polyester will be subject to temperatures of 325° F. or greater. To this end, the inventive filter assembly 10 incorporates a structure that is suitable for use with an inductive heating system. An inductive heating system will not expose the polyester-containing filter media to high temperatures. A metal member or metal disc 36 is utilized adjacent to the adhesive material 38. The metal disc 36 is excited by the inductive heating system thereby generating localized heat to cure the adhesive material 38.

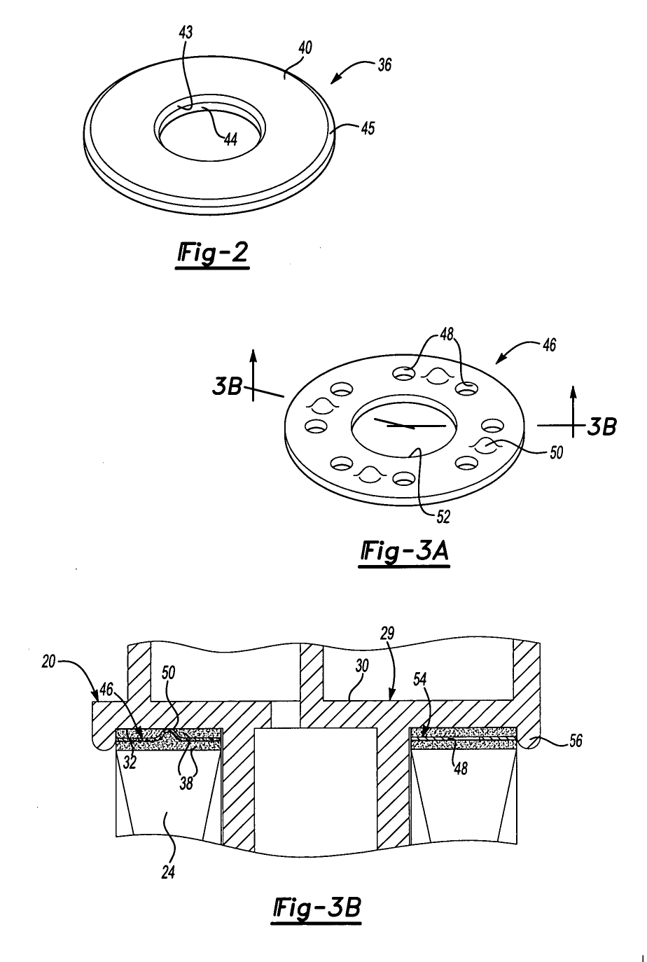

In a first example embodiment, the diverter 20 is molded over a metal disc 36, which is best shown in FIG. 2. The metal disc 36 has a back surface 40, which is arranged adjacent to the second side 32. The metal disc 36 provides an annular channel 42 opposite the back surface, in the example shown, for receiving the adhesive material 38 and filter media 24. The annular channel 42 is provided by inner and outer edges 43 and 45. An aperture 44 enables the center tube 22 to extend through the metal disc 36. Adhesive material 38 is received by the annular channel 42, and the end of the filter media 24 is embedded in the adhesive material 38, as best shown in FIG. 1.

In another example embodiment, a metal disc 46 includes multiple holes 48 and multiple dimples 50, which act as stand-offs. The metal disc 46 includes an aperture 52 for accommodating the center tube 22. Adhesive material 38 is arranged between the second side 32 and the metal disc 46. The dimples 50 space the metal disc 46 from the second side 32 providing a cavity 54 filled with the adhesive material 38. Adhesive material 38 is also arranged on the metal disc 46 opposite the cavity 54 and onto which an end of the filter media 24 is embedded. An annular lip 56 of the base 29 contains the adhesive material 38 in a desired area and locates the filter media 24 in a desired manner.

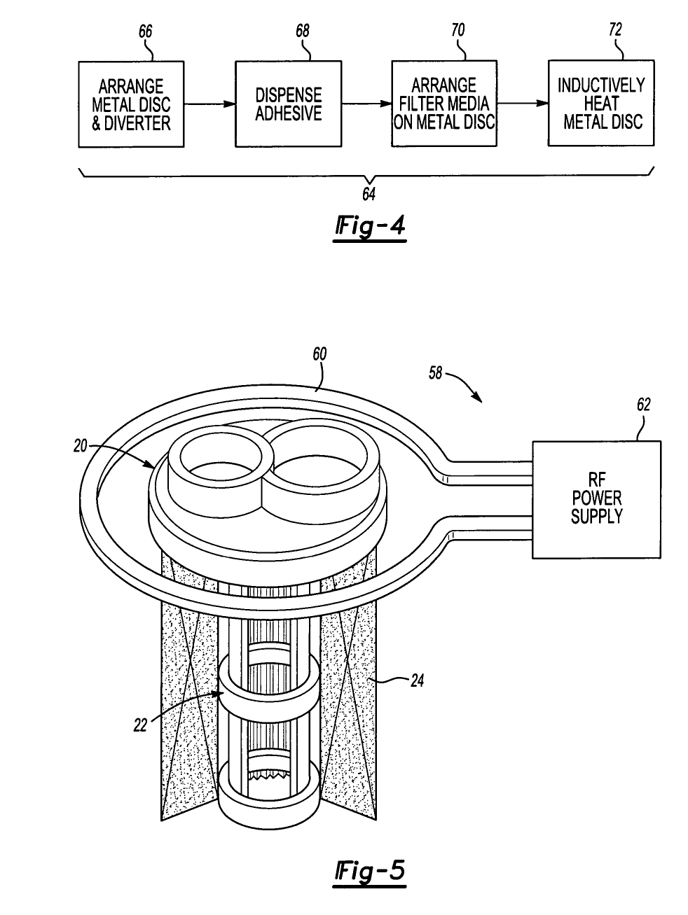

An inductive heating system 58 is schematically shown in FIG. 5 with the inventive method depicted by a flow chart in FIG. 4. Referring to FIG. 4, the method 64 includes arranging a metal disc 36 or 46 relative to the diverter 20. For example, this may be done by over-molding the diverter 20 relative to the metal disc 36 (FIG. 1) or by arranging the metal disc 46 relative to the diverter 20 subsequent to the forming of the diverter (FIG. 3B), as indicated at block 66. At block 68 an adhesive material 38 is dispensed onto the metal disc 36 or 46 and/or the diverter 20 to secure the filter media 24 and/or metal disc 36 or 46 to the diverter 20. However, it should be appreciated that adhesive material 38 may also be dispensed onto the filter media 24.

An end of the filter media 24 is embedded into the adhesive material 38 adjacent to the metal disc 36 or 46, as indicated at block 70. The metal disc 36 or 46 is inductively heated, as indicated at block 72, to cure the adhesive material 38.

Referring to FIG. 5, the inductive heating system 58 includes an induction coil 60 connected to an RF power supply 62. The RF power supply 62 generates a magnetic field with the induction coil 60. The magnetic field excites the metal disc 36 or 46 thereby heating the metal disc 36 or 46. The heat generated at the metal disc 36 or 46 is sufficient to cure the adhesive material 38 without producing damaging heat near the filter media 24. The details of inductive heating are well-known, and do not form a portion of this invention.

Although a preferred embodiment of this invention has been disclosed, a worker of ordinary skill in this art would recognize that certain modifications would come within the scope of this invention. For example, the metal discs 36 and 46 may be different shapes than shown. For that reason, the following claims should be studied to determine the true scope and content of this invention.

What is claimed is:

1. A filter assembly comprising:
a plastic base;
a metal member secured to the plastic base; and
a filter media secured to the metal member with a heat-curable adhesive material.

2. The assembly according to claim 1, wherein the plastic base is provided by a fuel filter diverter.

3. The assembly according to claim 2, wherein the filter media is a polyester-containing material.

4. The assembly according to claim 3, wherein the heat-curable adhesive material is a plastisol material.

5. The assembly according to claim 2, wherein the diverter includes a center tube integral with the plastic base and extending through a central opening in the filter media.

6. The assembly according to claim 1, wherein the metal member includes a locating feature embedded in the plastic base securing the metal member to the plastic base.

7. The assembly according to claim 6, wherein the locating feature is a peripheral edge of the metal member captured by the plastic base.

8. The assembly according to claim 1, wherein the heat-curable adhesive material is arranged between the plastic base and the metal member securing the plastic base and metal member to one another.

9. The assembly according to claim 8, wherein the metal member includes a stand-off engaging the plastic base and spacing the metal member therefrom forming a cavity between the plastic base and the metal member, the heat-curable adhesive material arranged in the cavity.

10. The assembly according to claim 9, wherein the metal member includes at least one hole in communication with the cavity, the heat-curable adhesive material extending from the filter media through the at least one hole and into the cavity.

11. A method of manufacturing a filter assembly comprising:
a) arranging a metal member relative to a plastic base;
b) dispensing a heat-curable adhesive material;
c) arranging a filter media on the metal member with the heat-curable adhesive material arranged therebetween; and
d) inductively heating the metal member to cure the heat-curable adhesive material.

12. The method according to claim 11, wherein step a) includes molding a plastic base over the metal member.

13. The method according to claim 11, wherein step a) includes adhering the metal member to the plastic base.

14. The method according to claim 11, wherein step b) includes dispensing the heat-curable adhesive material onto the metal member.

15. The method according to claim 11, wherein step b) includes dispensing the heat-curable adhesive material onto the plastic base.

16. The method according to claim 11, wherein step c) includes embedding an end of the filter media into the heat-curable adhesive material arranged on the metal member.

17. The method according to claim 11, wherein the filter media is heat sensitive.
